(19) United States
(12) Patent Application Publication
(10) Pub. No.: US 2007/0104231 A1
(43) Pub. Date: May 10, 2007

(54) Wavelength tunable resonator with a prism

(76) Inventor: Jochen Schwarz, Stuttgart (DE)

Correspondence Address: PERMAN & GREEN, 425 POST ROAD, FAIRFIELD, CT, 06824, US

(21) Appl. No.: 10/526,130

(22) PCT Filed: Aug. 30, 2002
(86) PCT No.: PCT/EP02/09675

§ 371 Date: Oct. 10, 2006

(51) Int. Cl. H01S 3/10

(52) U.S. Cl. 372/20

(57) ABSTRACT

A wavelength tunable resonator includes a first reflector for reflecting a beam of electromagnetic radiation towards a second reflector, said second reflector for reflecting said beam back towards said first reflector, said first and second reflector defining a resonator having an optical path length, a gain medium for emitting said beam towards said first and second reflector, a prism, within said optical path, to filter a wavelength of said beam and to redirect a portion of said beam comprising said filtered wavelength towards said second reflector, wherein said second reflector is movable with respect to other optical elements within said resonator for increasing or decreasing said optical path length, and wherein said prism is rotatable about an axis with respect to said other optical elements within said resonator for adapting said filtered wavelength to said increase or decrease of said optical path length.

### BACKGROUND OF THE INVENTION

The present invention relates to a wavelength tunable resonator.

Wavelength tunable resonators are acquiring an increasing importance, in industry, particularly in optical communication measurement device industry. Typical designs of wavelength tunable cavities are, e.g., provided by Liu, K. & Littmann, G. in “Novel Geometry for Single-Mode Scanning of Tunable Lasers”, Optics Letters 6 (3), p. 117-p. 118 (1981), or by Xu, G., Fujii, K.-I. & Nakayama, S. in “Experimental Study on a Prism—External—Resonator Semiconductor Laser with Dispersion Feedback”, Review of Laser Engineering, Vol. 25, No. 6, p. 431-p. 433, (1997).

### SUMMARY OF THE INVENTION

It is an object of the present invention to provide an improved wavelength tunable resonator. The object is solved by the independent claims. Preferred embodiments are provided by the dependent claims.

According to preferred embodiments of the invention a wavelength tunable resonator comprises at least two reflectors, which define the optical path length of a resonator. Both mirrors reflect an incident beam of electromagnetic radiation towards the respective other mirror. As a result of the resonator such defined, resonance modes form out of the electromagnetic radiation of the beam reflected between both mirrors. The wavelength of the respective resonance modes depends on the optical path length of the resonator.

A gain medium is placed within the resonator for amplifying or generating and emitting a beam of electromagnetic radiation into the resonator. The gain medium can be any light amplifying medium, in particular a semiconductor laser chip.

A prism is arranged within the optical path of the beam reflected between the mirrors. The prism refracts an incident beam depending on an incident angle between the direction of the beam and a normal direction applied to a first surface of the prism. The prism also comprises a second surface, which is inclined with respect to the first surface. The optical path of said beam exits the prism through said second surface towards the second reflector.

It is to be understood, that according to the present invention any substantially transparent device composed of dispersive material and having a first and a second surface, both surfaces being inclined with respect to each other for separating portions of an incident beam into beams of different refraction angles depending on their wavelength, is considered by the term “prism”. The first and/or the second surface of the prism may even be curved.

The prism comprises dispersive material, such that the beam exiting the prism, e.g., towards the second reflector has a particular wavelength range, which fulfills the condition of being reflected directly back towards the prism and the first reflector. Portions of the beam having different wavelengths refracted or redirected by the prism not fulfilling this condition will thus leave the resonator. Accordingly, the prism acts as a wavelength filter selecting a comparatively narrow wavelength range.

In order for the resonator to be tunable by wavelength, at least one of the reflectors is provided being moveable for increasing or decreasing the optical path length of the resonator. As a result the wavelengths of the resonance modes forming within the resonator are shifted.

The prism is provided with the feature of rotation, such that the incident angle with respect to the first surface of the prism can be varied. The rotation can be performed about an axis of rotation, which may, e.g. according to an embodiment of the present invention, advantageously extend along a line across the first surface of the prism, whereby said incident beam emitted from the gain medium intersects with the axis of rotation. Thus, the incident beam intersects the surface at a predetermined position irrespective of the incident angle of the beam with respect to the surface, or the actual rotation angle of the prism within the resonator, equivalently.

The effect of rotating the prism with respect to the other optical elements, i.e. the first and second reflectors, etc., is, that the beam exiting the prism through the second surface into the direction of the second reflector experiences a shift of the filter function defining said selected wavelength range. The filtered wavelength range depends on an angle defined by the incident beam reflected by the first reflector and/or emitted by the gain medium towards the prism and a line connecting the prism and the second reflector. The direction of movement of the second reflector is preferably arranged along this line. The advantage arises from the fact, that the only angle, which changes due to a rotation, is the incident angle. Accordingly, the rotation of the prism leads to a shift of the filtered wavelength range, while a movement of the second reflector leads to a tuning of the resonator resonance mode wavelength.

In a preferred, advantageous embodiment of the present invention the prism is connected to a means for rotating the prism, while the second reflector is connected to a means for moving the mirror, both means being connected to a common support. E.g., the means for rotating the prism can be a lever being rigidly connected to the prism and being connected to the support by means of a joint. The means for moving the second reflector can for example as well be mounted to the support. Moving the support then leads to a time coincidence of a rotation of the prism and a movement of the second reflector. Applying suitable dimensions to the lever, the prism can be rotated, such that a resonance mode selected by the filtered wavelength range is actually followed by the shifted filter function when tuning the resonator. In accordance with the present invention a mode-hop free tuning on a large wavelength range scale becomes feasible using a prism as a wavelength filter. Costs can be saved, since just one drive is needed in order to actuate the prism and the second reflector. Moreover, irregularities during the movement of the support act in the same way on the prism and on the second reflector, thus leading to an improved tuning result

### BRIEF DESCRIPTION OF THE DRAWINGS

Other objects and many of the attendant advantages of the present invention will be readily appreciated and become better understood by reference to the following detailed description when considering in connection with the accompanied drawings. Features that are substantially or functionally equal or similar will be referred to with the same reference sign(s).

FIG. 1 displays a wavelength tunable resonator according to the present invention in a tuning position selecting a short wavelength resonance mode,

FIG. 2 displays the same resonator as in FIG. 1, but in a position selecting a long wavelength resonance mode,

FIG. 3 displays a diagram representing the beam deviation for a prism with strong dispersion,

FIG. 4 displays an embodiment being arranged as a ring resonator.

### DETAILED DESCRIPTION OF EMBODIMENTS OF THE INVENTION

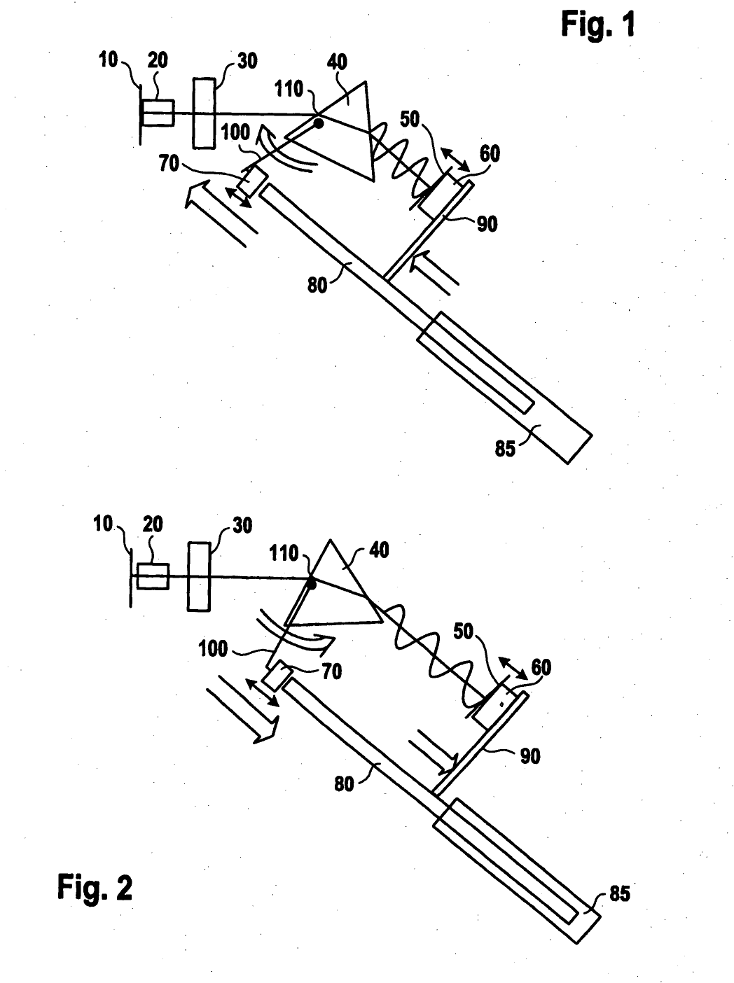

FIG. 1 displays a wavelength tunable resonator having a semiconductor laser diode as a gain medium 20, a first reflector 10 and a second reflector 50 according to the present invention. A beam 5 of electromagnetic radiation is generated and emitted by the gain medium 20 and reflected between the first and second reflectors 10, 50. A resonator lens 30 serves for collimating the beam 5 emitted from the gain medium 20 towards the second reflector 50.

A prism being composed of a photonic crystal is arranged within the optical path of beam 5 refracting the beam transmitted from the resonator lens 30 towards the second reflector 50. The material of the prism 40 has refractive indices in the range 1.5-1.7, thus being highly dispersive.

In the plane of the second reflector 50 a spectrum of the light beam emitted from prism 40 evolves, but only those portions of beam 5 are reflected towards the prism 40, which orthogonally fall towards the surface of the mirror 50. Other portions having different wavelength are not reflected to the prism 40 and thus leave the resonator. In FIG. 1 a wavelength is selected, which is comparatively short.

The prism 40 can be rotated around an axis of rotation 110 in order to shift the wavelength range that fulfills the condition of orthogonality upon the surface of the second reflector 50. It is to be understood that the same effect arises, when a retroreflector or other mirror-like reflectors are used instead of a plane mirror as the second reflector 50. In particular, the second reflector can be provided with a curved surface.

A lever 100 is connected with the prism 40 for rotating it about the axis of rotation 110. By means of a joint the lever 100 is connected with one end of a piezo actuator. The piezo actuator 70 is designed to fine-adjust the incident angle of beam 5 with respect to the surface of prism 40, which is orientated towards the resonator lens 30.

The other end of the piezo actuator 70 is connected to a movable support bar 80, which can be shifted and controlled by means of gas cylinder 85. A plate 90 is rigidly connected with support bar 80. The plate 90 mounted with one end of a second piezo actuator 60. The second piezo actuator 60 has another end, which is connected with the second reflector 50 for providing a fine-adjustment of the position of that mirror with respect to the plate position.

The direction of movement of the support bar 80 is parallel to the optical path of the beam 5 between the prism 40 and the second reflector 50. When the support bar 80 is shifted, as can be seen by the arrows in FIGS. 1 and 2, a rotation of the prism 40 and a movement of the second reflector 50 are effected. For example, the support bar 80 shift displayed in FIG. 2 increases the optical path length of the resonator resulting in a larger wavelength of a resonance mode under consideration. At the same time the prism 40 rotates such that the incident angle of the beam 5 with respect to the first surface of the prism becomes large.

The length of the different elements in the resonator and the motion of the prism are chosen, such that the resonator resonance mode is always close to the filter function curve of the prism 40. Using the resonator displayed in FIG. 1 a tuning in the wavelength range 1250 nm-1600 nm is fostered. In this embodiment the distance between the first reflector 10 and the prism amounts to 1 cm. The optical path within the prism amounts to 0.5 cm. The distance between the prism and the second reflector is variable and amounts to 0.5 cm at a tuned wavelength of 1250 nm and to 1.2 cm at a wavelength of 1600 nm. Accordingly a path difference is realized by a linear motion of the second reflector that amounts to 0.7 cm. The length of the lever 100 is 1.2 cm. A range of 28° of the incident angle is covered by the rotation motion enabled by a shift of the support bar 80. This results in an almost continuous tuning that can be adjusted for continuous tuning by piezo actuators.

Further embodiments of the present invention relate to one or more of the reflectors being semitransparent for outcoupling of beam portions. In case of the second reflector being semitransparent, a low source spontaneous emission (LSSE) outcoupling of light becomes possible.

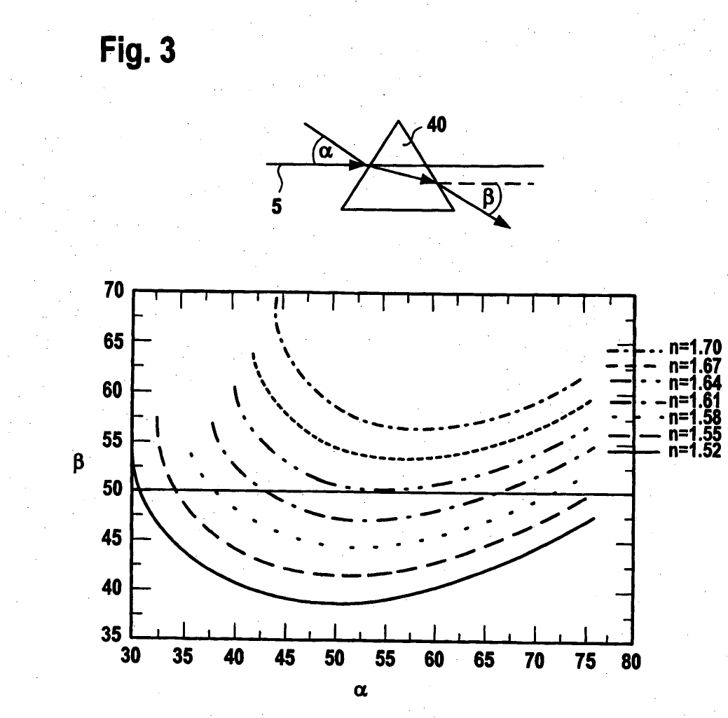

FIG. 3 illustrates the behavior of prisms 40 having different refractive indices n. The diagram shows an angle β that the output beam of the prism towards the second reflector 60 has with an incident beam 5, i.e., the prism deflection angle, as a function of angle α that the incident beam 5 has with a normal of the prism surface. In this embodiment angle β is held constant as is obvious from the embodiments shown FIGS. 1 and 2. A value of 50 degrees for β is indicated by a horizontal line in FIG. 3.

As incident angle α is, e.g., increased by the rotation movement according to the preferred embodiments of the invention, the refractive index of a prism 40, which provides the combination of angle α and angle β, approaches a maximum value first and decreases thereafter. A refractive index n of a prism is not easily changed once a prism is manufactured, however, it becomes clear that the varying refractive index n can be interpreted in terms of the varying tuning wavelength.

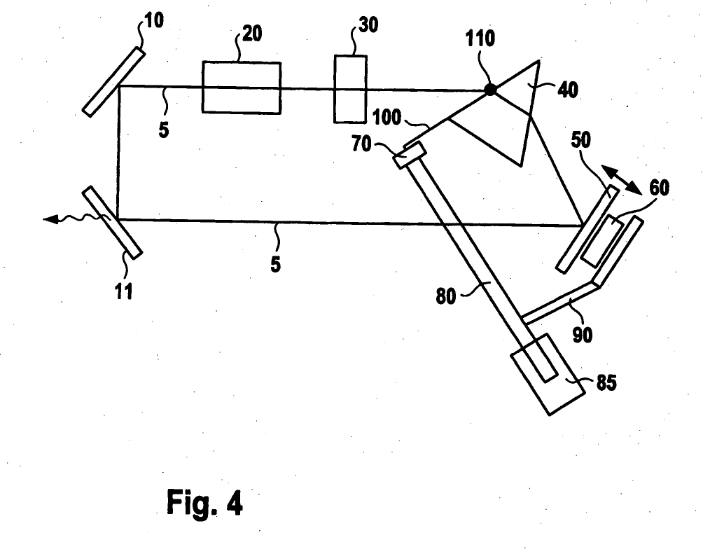

According to a further embodiment of the present invention the reflectors and the prism are arranged within a ring resonator as shown in FIG. 4, wherein the second reflector reflects the beam of electromagnetic radiation towards the first reflector via a second optical path, that does not transmit back through the prism 40. Rather, a third semitransparent reflector 11 is provided to admit beam 5 to be transmitted towards the first reflector. The third semitransparent reflector 11 serves for further outcoupling a portion of beam 5.

The resonator with a prism according to the present invention increases the quality of a resonator tuning process and/or simplifies the designs of wavelength tunable cavities thereby reducing costs and fostering further miniaturization.

1. A wavelength tunable resonator comprising:
a first reflector for reflecting a beam of electromagnetic radiation towards a second reflectors,
said second reflectors for reflecting said beam back towards said first reflector, said first and second reflector defining a resonator having an optical path with a length,
a gain medium for generating and emitting said beam towards said first and second reflector,
a prism, which is arranged within said optical path, serving to filter a wavelength of said beam,
wherein at least said second reflectors is arranged to be movable with respect to other optical elements within said resonator for increasing or decreasing said length of said optical path of said resonator, and
wherein said prism is arranged to be rotatable about an axis with respect to said other optical elements within said resonator for adapting said filtered wavelength range to said increase or decrease of said optical path length.

2. The resonator of claim 1,
wherein said gain mediums is a laser source comprising said first reflector as a back facet and having a front surface, through which said beam is emitted towards said second reflector.

3. The resonator of claim 1,
wherein said prism and said second reflector are mechanically coupled to a common support, said common support being movable by means of a drive for providing a combined movement of said second reflector and rotation of said prism.

4. The resonator of claim 3,
further comprising a first actuator for performing a fine-adjustment of said prism with respect to said means for rotating said prism.

5. The resonator of claim 3,
further comprising a second actuator for performing a fine-adjustment of said second reflector with respect to said means for moving said second reflector.

6. The resonator of claim 2,
further comprising a resonator lens for collimating said beam emitted from said laser source.

7. The resonator of claim 4,
wherein at least one of said first or second actuator is a piezo-actuator.

8. The resonator of claim 1,
wherein said prism comprises a photonic crystal.

9. The resonator of claim 1,
wherein said prism comprises a surface having an intersection point with said optical path of said incident beam, and
wherein said axis of rotation is arranged along a line upon said surface, said line running through said intersection point on said surface.

10. The resonator of claim 1, wherein said prism is designed to direct a portion of said incident beam comprising said filtered wavelength towards said second reflector.
